(19) United States
(12) Patent Application Publication
(10) Pub. No.: US 2007/0101010 A1
(43) Pub. Date: May 3, 2007

(54) Human interactive proof with authentication

(75) Inventors: Carl M. Ellison, Seattle, WA (US); Elissa E.S. Murphy, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/264,369

(22) Filed: Nov. 1, 2005

(51) Int. Cl. G06F 15/173; G06F 15/16

(52) U.S. Cl. 709/229; 709/225

(57) ABSTRACT

A method and system for authenticating that a user responding to a HIP challenge is the user that was issued the challenge is provided. Upon receiving information from a sender purporting to be a particular user, the authentication system generates a HIP challenge requesting information based on the user's identity. Upon receiving a response to the challenge, the authentication system compares the response with the correct response previously stored for that user. If the two responses match, the authentication system identifies the user as the true source of the information.

### BACKGROUND

Electronic communications such as electronic mail are being increasingly used for both business and personal uses. Electronic communications have many advantages over non-electronic communications such as postal mail. These advantages include low cost, rapid delivery, ease of storage, and so on. As a result of these advantages, there is also a common disadvantage of electronic communications, which is that many of the communications are undesired by the recipient. Such undesired electronic communications are referred to as junk mail, spam, and so on. Because of the low cost and speed, many organizations use electronic communications to advertise. For example, a retailer may purchase a list of electronic mail addresses and send an electronic mail message containing an advertisement for its products to each electronic mail address. It is not uncommon for a person to receive many such unwanted and unsolicited electronic mail messages each day. People receiving such junk electronic mail messages typically find them annoying. Junk electronic mail messages may also cause a person's inbox to become full and may make it difficult to locate and identify non-junk electronic mail messages.

Various techniques have been developed to combat junk electronic mail. For example, some electronic mail systems allow a user to create a list of junk electronic mail senders. When an electronic mail message is received from a sender on the list of junk electronic mail senders, the electronic mail system may automatically delete the junk electronic mail message or may automatically store the junk electronic mail message in a special folder. When a junk electronic mail message is received from a sender who is not currently on the junk electronic mail list, the recipient can indicate to add that sender to the list. As another example, some electronic mail systems may allow the recipient to specify a list of non-junk senders. If an electronic mail message is received from a sender who is not on the list of non-junk senders, then the electronic mail system may automatically delete or otherwise specially handle such an electronic mail message.

The effectiveness of such techniques depends in large part on being able to correctly identify the sender of an electronic mail message. Electronic mail systems, however, as originally defined in RFC 822 entitled “Standard for the Format of ARPA Internet Text Messages” and dated Aug. 13, 1982, provided no security guarantees. In particular, any sender could construct a message that looked like it came from any other sender. Thus, a recipient could not be sure of the true identity of the sender.

To help ensure that the sender is a human, rather than the program of a spammer, some electronic mail systems, upon receiving an electronic mail message from a sender (whose identity cannot be authenticated from the message itself) may automatically send an authentication request electronic mail message to the sender. The electronic mail system may also place the electronic mail message in a potential junk mail folder pending receipt of authentication information from the sender. The authentication request message may use human interactive proof (“HIP”) technology to ensure that a human responds to the authentication request. The authentication request may include a HIP challenge that is impossible or at least computationally expensive for a machine to answer, but relatively easy for a person to answer. For example, the HIP challenge may be an image containing an obscured word written in wavy or multicolored text that is difficult for a computer to recognize, but easy for a person to recognize. The HIP challenge may ask the sender to type in the word contained in the image, which a person can easily do. The HIP challenge may be presented in the authentication request message or by a web site identified in the message. When the electronic mail system receives the response to the challenge (e.g., via an electronic mail message or via the web site), it determines if the response is correct. If so, it may classify the original electronic mail message as not being junk by moving it to the recipient's inbox folder. Otherwise, it may discard the original message or move it to a junk mail folder.

Spammers are, however, beginning to find clever ways to respond to HIP challenges. In one scheme, a spammer upon receiving a HIP challenge presents the challenge to a legitimate but unsuspecting user of the spammer's web site. For example, the spammer may offer a product for sale on a frequently visited web site, and may present the HIP challenges received in the authentication request message as a step in the checkout process to the purchaser. Unsuspecting purchasers will provide correct responses to the HIP challenges, which the spammer then forwards on to the recipient of the original message as the response to authentication request.

### SUMMARY

A method and system for authenticating that a user responding to a HIP challenge is the user that was issued the challenge is provided. Upon receiving information from a sender purporting to be a particular user, the authentication system generates a HIP challenge requesting information based on the user's identity. For example, the sender may be the sender of an electronic mail message who is requesting that the message be delivered to the recipient's inbox folder. The HIP challenge may include a photograph of the user's child that the recipient has previously stored with the recipient's electronic mail server. The HIP challenge would then be accompanied by a request to type the name of the person in the picture. The user will recognize their child in the picture and know the correct name, but other senders (e.g., spammers) likely will not. Upon receiving a response to the challenge, the authentication system compares the response with the correct response previously stored for that user. If the two responses match, the authentication system identifies the user as the true source of the information. In the example of a user sending an electronic mail message, once the user is identified as the sender of the message the system allows the message to be delivered to the recipient's inbox folder. If the responses do not match, the authentication system may discard the message or deliver it to a junk mail folder.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates the components of the authentication system in one embodiment.

FIG. 2 illustrates a HIP challenge in a prior art system.

FIG. 3 illustrates a HIP challenge of the authentication system in one embodiment.

FIG. 4 is a flow diagram that illustrates the processing of an authenticate user component of the authentication system in one embodiment.

FIG. 5 is a flow diagram that illustrates the processing of an email authenticating component of the authentication system in one embodiment.

### DETAILED DESCRIPTION

A method and system for authenticating that a user responding to a HIP challenge is the user that was issued the challenge is provided. In some embodiments, upon receiving information from a sender purporting to be a particular user, the authentication system generates a HIP challenge requesting information based on the user's identity. For example, the sender may be the sender of an electronic mail message who is requesting that the message be delivered to the recipient's inbox folder. The HIP challenge may include a photograph of the user's child that the recipient has previously stored with the recipient's electronic mail server. The HIP challenge would then be accompanied by a request to type the name of the person in the picture. The user will recognize their child in the picture and know the correct name, but other senders (e.g., spammers) likely will not. Another example of a HIP challenge with user-based knowledge is an image that requests in obscured text that the user type their favorite color. Upon receiving a response to the challenge, the authentication system compares the response with the correct response previously stored for that user. If the two responses match, the authentication system identifies the user as the true source of the information. In the example of a user sending an electronic mail message, once the user is identified as the sender of the message the system allows the message to be delivered to the recipient's inbox folder. If the responses do not match, the authentication system may discard the message or deliver it to a junk mail folder.

By combining human interactive proof with user-based knowledge, the authentication system provides a dual benefit. First, the human interactive proof validates that information received comes from a person and not a machine. Second, the user-based knowledge ensures that the information comes from the intended person, and not some other person. Thus, neither a legitimate sender nor a spammer can effectively use a machine to send a flood of requests because the human interactive proof will force a person to respond manually. Also, a spammer or other illegitimate user cannot effectively send even a single request because they do not possess the user-based knowledge. One example of the dual benefit of the authentication system is the situation where a HIP challenge with a password is used to protect access to an online chat room. The password prevents unauthorized users from entering the chat room, but the human interactive proof prevents even an authorized user from spamming the chat room through scripting or other automated means.

In some embodiments, the authentication system requests user-based knowledge that is commonly known, but more likely to be known by the intended user. For example, a web site may want to authenticate its users. The site may detect from the user's Internet Protocol (IP) address that the user is in Chicago, and may present a HIP challenge that asks the user to name the city's mayor. The intended user is more likely to know the answer than an unsuspecting person enlisted by a spammer to answer the question since the unsuspecting person is unlikely to be located in the same city as the intended user.

In some embodiments, the authentication system requests a shared secret from the user. For example, a user attempting to join a private group of users may be shown an image of an obscured word accompanied by a request to type the word and append a group password that was communicated to them by a member of the group. The group password may simply be information that a real person joining the group would know, such as the name of the group leader. This method validates that the user both is not a machine and has some valid prior association with the group. If only a password was requested without human interactive proof, then a devious member of the group could write a script to bring down the group by sending thousands of join requests.

In some embodiments, the authentication system provides context information within the HIP challenge that indicates its purpose. For example, the HIP challenge may contain an image that states that it is from a web site selling tickets accompanied by text that the user should enter if they are intending to visit a web site for that purpose. If a malicious user displays such an image to an innocent user in order to enlist the user to unknowingly help them overcome the HIP challenge, the user will have enough information to know that the request is counterfeit and can decline to answer the HIP challenge.

In some embodiments, the authentication system allows an unsuspecting user to inform the site owner or email recipient that a HIP challenge has been distributed outside of its original context. Using the previous example, the HIP challenge with an image that states that it is from a web site selling tickets may contain obscured text that asks the user to type one response if they are seeing the image in its proper context, or another response if the context is wrong. For example, the image might contain text that says, “If you are seeing this image at www.tickets.com, type ‘Go Nationals’; otherwise, type ‘Counterfeit.’” In the electronic mail example, the image might contain text that says, “If you sent an email to Joe Smith, type ‘Go Joe’; otherwise, type ‘Counterfeit.’” Once the authentication system receives a response of “Counterfeit,” it knows that the request was from a malicious user.

In some embodiments, the authentication system prevents a malicious sender from sending an electronic message on behalf of a legitimate sender. First, the spam message may purport to be from a legitimate sender, but the message may include the “from” email address of the malicious user, in which case the authentication system will send a challenge to the spammer that the spammer must correctly answer in order for the message to be delivered (costing the spammer time and money to employ a person to respond). Second, the message may include the “from” email address of the legitimate sender even though it is in fact sent by a spammer. In this instance, the authentication system will send a challenge to the legitimate sender's email address, and the legitimate sender will not recognize the message as one that they sent. The legitimate sender will then either ignore the challenge or respond that it is spam. Finally, the spam message may include the “from” email address of a bogus user, in which case the authentication system will send the challenge to a bogus address, and no response will be received. A variation of these possibilities is that the spammer could be operating as a “man in the middle” as is commonly understood in the art, such that regardless of the sender identified in the message, the spammer is able to receive any challenges related to the message. One example of this is the electronic mail administrator of a system that is able to view messages sent to any user of the system. The administrator could send a message purporting to be from a user of the system, and could intercept challenges to that user; however, the spammer still must expend time and money to have a person correctly respond to the challenge, and that person would need to possess the user-based knowledge.

In the previous example, the sender of an electronic mail message could receive a HIP challenge that includes an image with obscured text asking the user to finish a particular sentence from the message. Only the original sender of the message would be able to correctly answer the HIP challenge. Even the real sender (such as a spammer who identifies their correct sender address in the message) cannot use scripting or other automatic means to respond to the challenge because of the human interactive proof. If the malicious sender employs someone to read and respond to such a challenge, the malicious sender is still deterred by the expense of having human readers handle the challenge. By forcing the malicious sender to spend money to overcome the HIP challenges, the authentication system will deter the malicious sender and reduce the sender's negative impact.

In some embodiments, the authentication system uses personal knowledge shared between the intended user and the site being visited. For example, if a web site sends a user an email notification that the user has won a prize, and the user later visits the site to claim the prize, the web site could offer a HIP challenge to the user that includes an image with obscured text asking the user to finish a particular sentence from the email. Only the user that received the email would be able to correctly answer the HIP challenge, and a machine with access to the user's email could not overcome the obscured image. The personal information could be shared in other ways; for example, a credit reporting agency could ask a user to provide the approximate balance of one of their credit accounts combined with a HIP challenge to authenticate the user.

In some embodiments, the authentication system automatically determines a correct response to a HIP challenge based on the response most commonly received. For example, the authentication system may have a database of nature pictures and ask a user seeking admission to a nature site to identify what is in the image. Rather than storing correct responses for every image in the database, the authentication system may simply select the response most commonly received as the correct response. An unsuspecting user is unlikely to provide the correct response if the subject matter of the images is not generally understood.

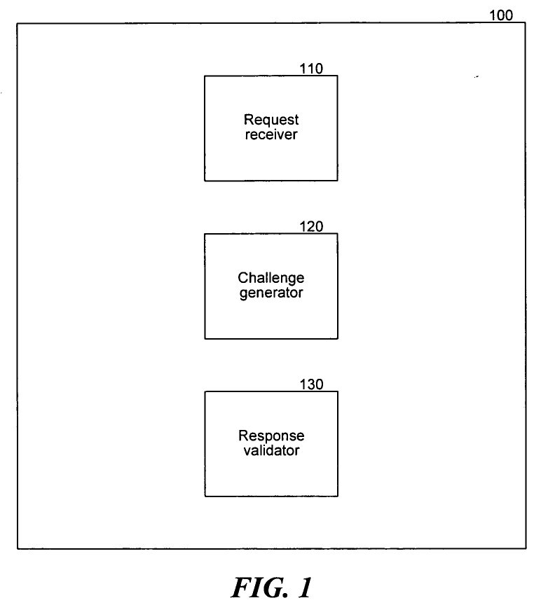

FIG. 1 is a block diagram that illustrates the components of the authentication system in one embodiment. The authentication system 100 contains a request receiver component 110, a challenge generator component 120, and a response validator component 130. The request receiver 110 receives a request to access a resource from a user and initiates the authentication process. The challenge generator 120 generates a HIP challenge that is appropriate for the requesting user as well as generating a correct response. For example, the challenge generator 120 may retrieve personal information about the user from a data store and use the information to generate a HIP challenge and correct response. The response validator 130 receives a response to the HIP challenge from the user and compares it with the correct response. If the response is correct, the user is granted access to the resource; otherwise, the user is denied access to the resource.

The computing device on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

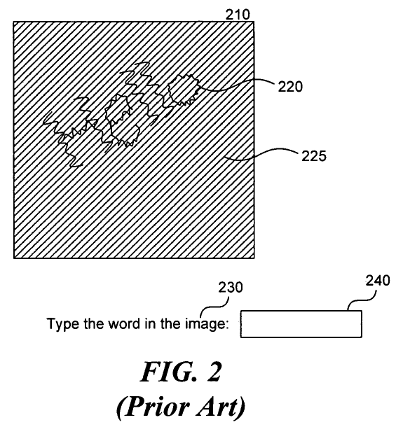

FIG. 2 illustrates a HIP challenge in a prior art system. The HIP challenge contains an image 210, accompanying text 230, and a response box 240. The image 210 contains text 220 that is written in a wavy font that is difficult for a computer to read. The image 210 may also be obscured by lines 225 or a hatch pattern. The text 220 in the image is readable by a human reader. The accompanying text 230 asks the user a question about the image that uses only knowledge from the image itself. The response box 240 is a place for the user to enter a response to the HIP challenge. The user then submits the response for validation.

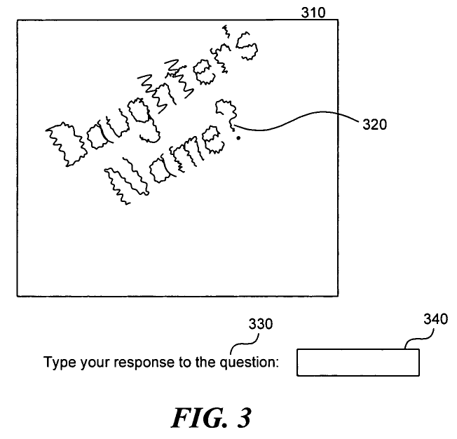

FIG. 3 illustrates a HIP challenge of the authentication system in one embodiment. The HIP challenge contains an image 310, accompanying text 330, and a response box 340. The image 310 contains text 320 that is written in a wavy font that is difficult for a computer to read. The substance of the text 320 is knowledge that is external to the image 310 such that only the intended person could respond to the HIP challenge correctly. The accompanying text 330 asks the user to enter their response to the question in the image, and the response box 340 provides a location for the user to enter the response. The intended person will be able to answer the HIP challenge correctly and gain access to the resource protected by the HIP challenge.

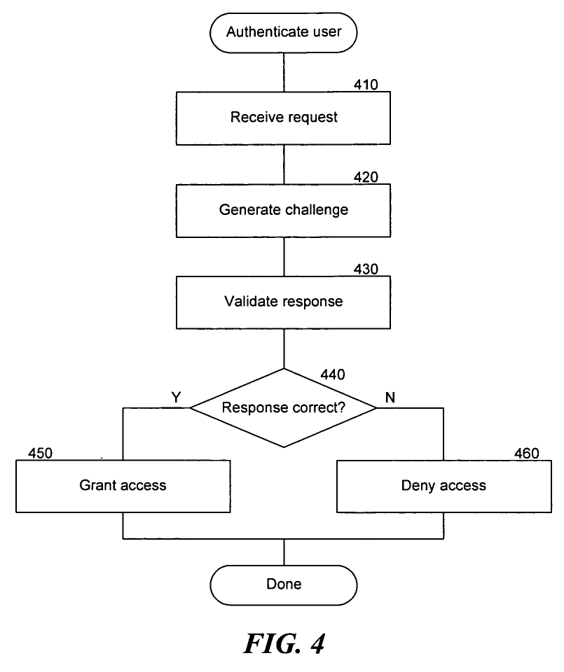

FIG. 4 is a flow diagram that illustrates the processing of an authenticate user component of the authentication system in one embodiment. The authenticate user component uses the request receiver component, challenge generator component, and response validator component to verify that a user providing information to the authentication system is in fact the user that they claim to be. In block 410, the component receives a request from a user to access a resource. In block 420, the component generates a HIP challenge that requests knowledge that the requesting user is more likely to know than an average user. In block 430, the component compares the user's response to a correct response. In decision block 440, if the user's response matches the correct response, then the component continues at block 450, else the component continues at block 460. In block 450, a user that has responded correctly to the HIP challenge is granted access to the requested resource. In block 460, a user that has not responded correctly is denied access to the requested resource. The component then completes.

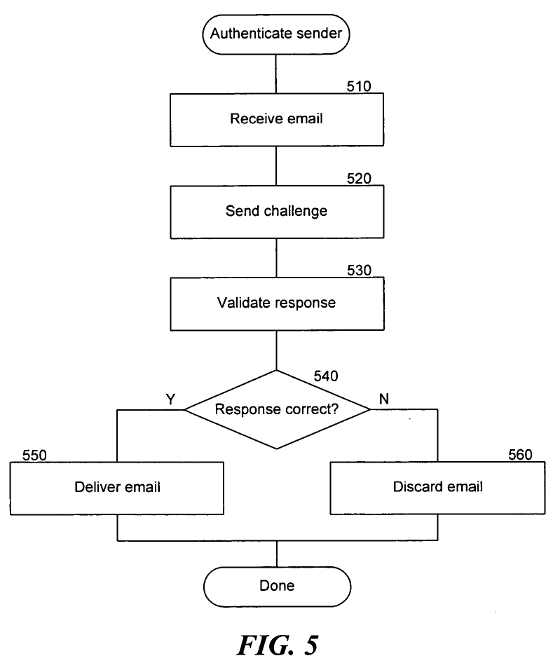

FIG. 5 is a flow diagram that illustrates the processing of an email authenticating component of the authentication system in one embodiment. In block 510, the component receives an electronic mail message from a sender and stores the message in a suspect message folder. In block 520, the component generates a HIP challenge that requests knowledge based on the identity of the user that the sender purports to be and sends the challenge to the sender. In block 530, the component receives a response from the sender and compares the response to a correct response stored previously. In decision block 540, if the sender's response matches the correct response, then the component continues at block 550, else the component continues at block 560. In block 550, the message of a sender that has responded correctly to the HIP challenge is delivered to the inbox of the recipient of the message. In block 560, the message of a sender that has not responded correctly is discarded or delivered to a junk mail folder. The component then completes.

From the foregoing, it will be appreciated that specific embodiments of the authentication system have been described herein for purposes of illustration, but that various modifications may be made without deviating from the spirit and scope of the invention. The authentication system has been described in the context of sending email and accessing a web site, but the system could also be applied to other situations. For example, an email system could request that a recipient of an email validate their identity before allowing further access to the system using the techniques described. A family photo album shared online could use the authentication system to ensure that only family members are able to access pictures. The authentication system has been described as using information previously shared between a user and a site in the form of text; however other more complicated methods could be used to authenticate the user. For example, the information could be a random number generated by a synchronous key held by both the user and the site. Alternatively, the user could be asked to encrypt text contained in a HIP image using the user's private key, for which the site knows the user's public key. The authentication system has been described in the context of using HIP images, but other methods that are easier for a human to answer than a machine could also be used. For example, the HIP challenge could be an audio clip of a person's favorite song or of the voice of the person's mother, with a challenge that asks that the audio be identified. Each of these methods involve information that the intended user is more likely to possess than other users. Accordingly, the invention is not limited except as by the appended claims.

I/We claim:

1. A method in a computer system for verifying the identity of a person, the method comprising:
receiving information purporting to be from the person;
sending a challenge to the person, wherein the challenge is in a form that is easier for a human to answer than a machine, and wherein the challenge requests knowledge that is based on the identity of the person;
receiving a response to the challenge;
comparing the received response to a correct response; and
if the received response matches the correct response, identifying the person as the source of the information.

2. The method of claim 1 wherein the information is an electronic mail message sent by the person.

3. The method of claim 2 including, upon identifying the person as the source of the electronic mail message, delivering the electronic mail message to the inbox folder of the recipient.

4. The method of claim 2 including if the received response does not match the correct response, delivering the electronic mail message to a junk mail folder of the recipient.

5. The method of claim 2 including if the received response does not match the correct response, discarding the electronic mail message.

6. The method of claim 1 wherein the form of the challenge is an image containing obscured text.

7. The method of claim 1 wherein the knowledge is personal information about the person.

8. The method of claim 1 wherein the knowledge is commonly known to others sharing an attribute with the person.

9. The method of claim 1 wherein the knowledge is a previously shared secret.

10. The method of claim 1 wherein the information requests access to a resource accessible to a group of users and the knowledge is information shared by the group with prospective members.

11. The method of claim 1 wherein the challenge contains context information based on the resource that is requested.

12. The method of claim 11 wherein the challenge requests a separate response if the person believes the challenge is being applied outside of its intended context.

13. The method of claim 1 wherein the knowledge is information shared between the person and a resource in a previous communication.

14. The method of claim 13 wherein the previous communication is an electronic mail message from the resource to the person.

15. The method of claim 1 wherein the information is access information for authenticating the person to access a web site.

16. The method of claim 1 wherein the correct response is automatically generated based on the response most commonly received.

17. A computer-readable medium containing instructions for verifying the identity of a person, by a method comprising:
receiving a request to access a resource, the request purporting to be from the person;
sending a challenge, wherein the challenge includes a human interactive proof challenge, and wherein the challenge requests external information that the person is more likely to know than people generally;
receiving a response to the challenge;
comparing the received response to a correct response; and
if the received response matches the correct response, identifying the person as the source of the request.

18. A system for verifying the identity of a person comprising:
a request receiving component;
a challenge generating component, wherein a challenge is in a form that includes human interactive proof, and wherein the challenge requests external information that the person is more likely to know than people generally; and
a response validating component.

19. The system of claim 18 wherein the external information is personal information about the person.

20. The system of claim 18 wherein the external information is information shared between the person and a resource in a previous communication.
